(19) United States
(12) Patent Application Publication
(10) Pub. No.: US 2003/0017939 A1
(43) Pub. Date: Jan. 23, 2003

(54) Catalyst system for the polymerization of olefins

(76) Inventors: Yoshikuni Okumura, Frankfurt am Main (DE); Toshiaki Ishikawa, Oita-shi (JP)

Correspondence Address: Joanne W Patterson, Basell North America, Intellectual Property, 912 Appleton Road, Elkton, MD, 21921, US

(21) Appl. No.: 10/169,824

(22) PCT Filed: Oct. 25, 2001
(86) PCT No.: PCT/EP01/12427

(30) Foreign Application Priority Data
Nov. 13, 2000 (JP) 2000-345595
Feb. 13, 2001 (JP) 2001-036044

(51) Int. Cl. B01J 31/00

(52) U.S. Cl. 502/103; 502/150; 502/102; 502/118; 526/170; 526/943; 526/905

(57) ABSTRACT

A catalyst system comprising an oxidizing agent, a titanium complex represented by the formula, Z R″ₘZ′TiQₖA₁ (wherein Z and Z′ represent π-bonding ligand or σ-bonding ligand; R″ represents abridging moiety; Q represents straight or branched an alkyl, aryl, alkenyl, alkylaryl, arylaklyl group or a halogen atom; A represents a counteranion; k is an integer from 1 to 3; l is an integer from 0 to 2; and m is an integer from 0 to 3 and a Lewis acid compound.

The present invention relates catalyst system for the polymerization of olefins comprising a titanium complex as catalyst component.

Recently, practical application of single site catalysts e.g., metallocene catalysts has been widely carried out. Especially, for IV group transition metal catalysts (the central metal is Ti, Zr and Hf), many catalyst systems including metallocene catalysts (a combination of a metallocene compound having a sandwich structure of cyclopentadienyl rings with a Lewis acid compound such as methyl aluminoxane) for stereoregular polymerization of α-olefin such as propylene have been reported.

Metallocene compounds having Ti as acentral metal (titanocene catalysts) have a behavior completely different from those having Zr (zirconocene catalysts) or Hf (hafnocene catalysts). They revealed extremely low polymerization activity as reported in J. Organometallic Chemistry, 479 (1994) 1-29, where the order of polymerization activity depending on central metals results to be Zr>Hf>>Ti (page 24, line 13 to 16) or in J. Am. Chem. Soc., 1989, 109, 6544, J. Organometallic Chemistry, 434 (1992) Cl where the polymerization activity of titanocene catalysts has been described to remarkably decline under the polymerization conditions. However the polymers obtained with the titanocene catalyst have interesting features. For example, in Macromol. Rapid Commun., 19, 71-73 (1998) it has been reported that polypropylene obtained with dimethylsilyl-bis (2-methyl-4-phenyl-1-indenyl)TiCl₂ shows an higher melting point (165° C.) than the polypropylene obtained with the zirconium analog. Therefore, it should be desirable to find a method for improving polymerization activity of titanocene catalysts.

The present invention provides a catalysts system having an enhanced activity comprising the product obtainable by reacting:

(A) an oxidizing agent which can oxidize Ti(II) and Ti(III), in a radical coupling manner;

(B) a titanium complex represented by the general formula (I);

Z R″ₘZ′TiQₖA₁ (I)

wherein

(a) Z and Z′ may be identical or different and each represents a π-bonding ligand or a σ-bonding ligand;

(b) R″ represents a bridging moiety;

(c) Q represents a straight or branched alkyl, aryl, alkenyl, alkylaryl, arylalkyl group or a halogen atom;

(d) A represents a counteranion;

(e) k is an integer from 1 to 3;

(f) l is an integer from 0 to 2; and

(g) m is an integer from 0 to 3; and

(C) a Lewis acid compound.

Preferably the catalyst system object of the present invention comprises the product obtainable by reacting:

(A) an oxidizing agent which can oxidize Ti(II) to Ti(IV), in a radical coupling manner;

(B) a titanium complex of formula (II);

Z R″ₘZ′TiQₖ (II)

wherein

Z is an unsubstituted or substituted cyclopentadienyl group, optionally condensed to one or more unsubstituted or substituted, saturated, unsaturated or aromatic rings, containing from 4 to 6 carbon atoms, optionally containing one or more heteroatoms belonging to groups 13-17 of the Periodic Table of the Elements; Z′ is 0, S, NR¹ or PR¹, R¹ being hydrogen, a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl, or Z′ has the same meaning of Z;

R″ is a divalent radical selected from the group consisting of: linear or branched, saturated or unsaturated C₁-C₂₀ alkylidene, C₃-C₂₀ cycloalkylidene, C₆-C₂₀ arylidene, C₇-C₂₀ alkylarylidene or C₇-C₂₀ arylalkyldene radicals, optionally containing one or more Si, Ge, O, S, P, B or N atoms;

Q is selected from the group consisting of, halogen atoms or a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl group, optionally containing one or more Si or Ge atoms;

k is 2; and

m is 0 or 1; and

(C) a Lewis acid compound.

Each catalyst component in the catalyst systems used for the method of the present invention is described below.

(A) Oxidizing agents

For the purpose of the present invention the oxidizing agents are compounds which can oxidize Ti of low valences Ti [Ti(II), Ti(III)] in a radical coupling manner, preferably the oxidizing agents oxidizes Ti(II) to Ti(IV). Thus, they are used in a broader sense than oxidizing agents used in a general mean.

Some examples of the compounds which oxidatively add to Ti of low valences are known. For example, they are described in “Titanium Complexes in Oxidation States +2 and +3” in Section 4 of Comprehensive Organometallic Chemistry II (Pergamon) Volume 4. However, no example in which these oxidizing agents were used for catalysts system of olefin polymerization has been known.

Specific examples of the oxidizing agents in the present invention are listed below.

(A-1) Hydrogen and hydrogen compounds:

These compounds are the compound group which oxidatively add to Ti of low valences, and for example, the followings can be included.

Hydrogen (H₂)

BH₃, AlH₃, NH₃, PH₃, AsH₃, SbH₃;

H₂O, H₂S, H₂Se, H₂Te;

Halogenated hydrogen (HCl, HBr, HI, and the like);

Metallic hydrogenates (interstitial compounds each comprising a transition metal and, e.g., PdHₓ, TiHₓ and the like.);

(A-2) Electrophilic reagent (general oxidizing agents): for example;

Halogens (chlorine, bromine, iodine, and the like);

Halogenated alkyl (methyl iodide, and the like);

Hypohalogenate salts (NaOCl, KOBr, NaOBr, and the like);

Halogenate salts (NaClO₃, KClO₃, NaIO₃, KIO₃);

Periodate salts and periodic acid (H₅IO₆, NaIO₄, KIO₄);

N-halocarboxylate amido (N-bromosuccinimide, N-bromoacetamide, N-bromophthalimide, and the like);

Sulfides and the like (R—(X)ₙ—R), [wherein X is S or Se atom; R is an alkyl group, an aryl group and the like; n is an integer from 1 to 3; for example, Ph₂S₂, trisulfide RSSSR (R=p-tol, i-Pr, t-Bu or CH₂Ph)]

Metallic compounds including metallic atoms of high atomic values such as metallic salts, metallic oxides.

MX₄ (M=Ti, Zr, Hf; X=alkyl group, aryl group, (substituted) cyclopentadienyl group, halogens, and the like which may be the same or different), NH₄VO₃, VCl₄, VOCl₃, CrO₃, Na₂Cr₂O₇, CrO₂Cl₂, Na₂WO₄, KMnO₄, MnO₂, Mn(OAc)₃, FeCl₃, K₃Fe(CN)₆, K₃[Fe(CN)₆], RuO₄, OsO₄, Co(Cl₄)₃, Co(OAc)₂, NiO₂, Pd(OAc)₂, PdCl₂, PtCl₂, CuCl, CuCl₂, C(OAc)₂, CuSO₄, Ce(HSO₄)₄, Ag₂O, AgNO₃, HAuCl₃, Hg(OCOCH₃)₂, HgO, NaBO₃, Sn(OAc)₂, Pb(OAc)₂, PbCl₂, Pb(OAc)₄, PbO₂, SeO₄, Ce(O₂CCH₃)₄, AsO₃, Na₃AsO₄, SbF₅, NaBiO₃, Bi₂O₃, and the like;

Oxygen(O₂), ozone(O₃), hydrogen peroxide (H₂O₂);

Organic peroxides (PhCOO₂-t-Bu, t-BuO₂H, (PhCO₂)₂, (i-Pr-OCO₂)₂);

Organic peracids (PhCO₃H, m-ClC₆H₄CO₃H, HCO₃H, CF₃CO₃H, CHCO₃H, K₂S₂O₈);

Inorganic nitrogen compounds (HNO₃, N₂O₃, N₂O, N₂O₄, ON(SO₃K)₂);

Organic compounds (dimethylsulfoxide, quinones (2,3-dichloro-5,6-dicyanno-1,4-benzoquinone, tetrachloro-1,2-benzoquinone, tetrachloro-1,4-benzoquinone, and the like), nitro compounds (nitrobenzene, and the like), pyridine-N-oxide, carbon disulfide, carbon dioxide, and the like);

(A-3) Unsaturated organic compounds: for example;

Azo compounds (RN=NR (R=Ph or p-Tol; or R₂N₂=benzo[c]cinnoline), RC(O)N=NC(O)R (R=p-tolyl, OEt, O-t-Bu or MeC₆H₄O));

Unsaturated dicarboxylic acid (maleic acid, and the like);

Ethylene, α-olefin (1-propene, 1-butene, 1-pentene, and the like);

Acetylene derivatives (1-propyne, t-butylacetylene, diphenylacetylene, and the like);

Nitriles, RCN (R=Et, t-Bu or p-MeC₆H₄);

Preferred oxidizing agent are those compounds able to oxidize in a coupling manner Ti(1) to Ti(IV) for example:

halogens (chlorine, bromine, iodine, and the like);

halogenated alkyl of formula R⁶T¹ₙ wherein T¹ a halogen atom, R⁶ is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl hydrocarbon in which n hydrogen are substituted with T¹ atoms and n ranges from 1 to 5, preferably n is 1 and T¹ is iodine; examples of these compounds are methyl iodide, methyl bromide, benzil iodide, benzil bromide;

transition metal salts of formula T²T¹ₙ² wherein T² is a metal of group 8-15 of the periodic table, T¹ is a halogen atom preferably chlorine and n2 is equal to 1 or 2 depending of the oxidation state of the metal, preferred compound is PbCl₂;

Organic transition metal compound of formula R⁶—T³—T³—R⁶ wherein R⁶, equal to or different from each other, is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl radical; preferably R⁶ is a C₁-C₁₀ alkyl radical; T³ is tin (Sn) or lead (Pb).

(B) Titanium Complex

A titanium complex of the present invention is represented by said general formula (I). Specific examples of the compounds in the general formula (I) are described below.

(a) The following groups can be exemplified as Z and Z′.

(a-1) π-Bonding Ligands

Allyl, cyclobutadienyl, cyclopentadienyl, arene, cyclooctatetraenyl group, and the like. These may comprise typical elements of 4B, 5B and 6B groups in addition to carbon atoms.

Example of π-Bonding ligands are: cyclopentadienyl, mono-, di-, tri- and tetra-methyl cyclopentadienyl; 4-tertbutyl-cyclopentadienyl; 4-adamantyl-cyclopentadienyl; indenyl; mono-, di-, tri- and tetra-methyl indenyl; 4,5,6,7-tetrahydroindenyl; fluorenyl; 5,10-dihydroindeno[1,2-b]indol-10-yl; N-methyl- or N-phenyl-5,10-dihydroindeno [1,2-b]indol-10-yl; 5,6-dihydroindeno[2,1-b]indol-6-yl; N-methyl-or N-phenyl-5,6-dihydroindeno[2,1-b]indol-6-yl; azapentalene-4-yl; thiapentalene-4-yl; azapentalene-6-yl; thiapentalene-6-yl; mono-, di- and tri-methyl-azapentalene-4-yl and 2,5-dimethyl-cyclopenta[1,2-b:4,3-b′]-dithiophene.

(a-2) σ-Bonding Ligands

Ligands by which typical elements of 4B, 5B and 6B groups in the long-period periodic table form σ-bonding with Ti.

4B Group (C, Si, Ge, Sn)

For example, alkyl, aryl, alkenyl, alkylaryl, arylalkyl alkylsilyl, arylsilyl groups

5B Group (N, P)

alkylamide, imido, diimido, diimino, amidinate groups;

6B group (O, S, Se, Te)

alkoxy, aryloxy, alkylthio, arylthio groups

preferably the σ-Bonding ligand is a N-methyl, N-ethyl, N-isopropyl, N-butyl, N-phenyl, N-benzyl, N-cyclohexyl or N-cyclododecyl. radical.

(b) R″ is a bridging structure, and the structures represented below can be exemplified.

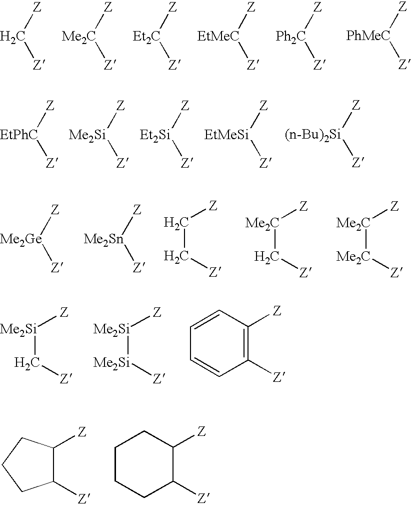

preferably R″ is Si(CH₃)₂, SiPh₂, CH₂, (CH₂)₂, (CH₂)₃ or C(CH₃)₂.

(c) preferably Q is a methyl, benzyl group or a chlorine atom.

(d) A is a counter anion, preferably a non-coordinated anion or extremely weakly coordinated anion for titanocene cation. The size of A is varied depending on the coordination structure of counter cation of titanocene.

(e) k is an integer from 1 to 3, preferably k is 2.

(f) 1 is an integer from 0 to 2. When l=0, the formula (1) is a neutral titanium complex and a catalytic precursor. When l=1 to 2, the formula (1) represents the ion pair between the cation of titanium complex and the non-coordinated anion. This is obtained from the reaction of the catalytic precursor when l=0 with (c) Lewis acid compound, preferably l is 0.

(g) m is an integer from 0 to 3, preferably m is 1.

When Z and Z′ are π-bonding ligands including (substituted) cyclopentadienyl ring, the structures of Z and Z′ are classified as follows depending on the difference of the integer m.

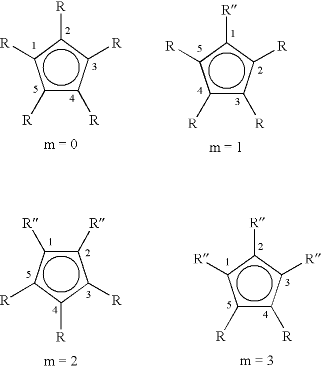

Specific examples of (substituted) cyclopentadienyl rings are shown as follows; Cp, MeCp, EtCp, i-PrCp, n-BuCp, 1,3-Me₂Cp, 1,3,4-Me₃Cp, Me₅Cp, Ind, 2-MeInd, 2-EtInd, 3-MeInd, 3-t-BuInd, 2-i-PrInd, 2,4-Me₂Ind, 2,4,7-Me₃Ind, 2-Me-4-i-PrInd, 2-Me-4-PhInd, 2-Me-4-(1-Naph)Ind, 2-Me-Benz[e]Ind, Flu, 2,7-Me₂Flu, 2,7-t-Bu₂Flu, wherein the brevity codes mean the following (substituted) cyclopentadienyl groups.

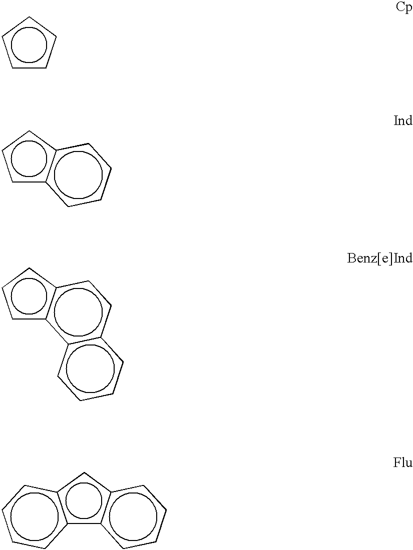

Further, (substituted) cyclopentadienyl rings containing heteroatoms include 5-methyl-cyclopenteno[b]thiophene, 2,5-dimethyl-1-phenyl cyclopenteno [b] pyrrole, and cyclopenteno[1,2-b:4.3-b′]dithiaophene described in J. Am. Chem. Soc., 1998, 120, 10786. When Z and Z′ are π-bonding ligands including (substituted) cyclopentadienyl rings which may contain heteroatoms, and when Q=Cl, k=2 and l=0, specific examples are shown below:

CpTiCl₃, Cp₂TiCl₂, (MeCp)₂TiCl₂, (EtCp)₂TiCl₂, (n-BuCp)₂TiCl₂, (Me₅Cp)₂TiCl₂, EtInd₂TiCl₂, Me₂Si(Ind)₂TiCl₂, Me₂Si(2-MeInd)₂TiCl₂, Et(2,4,7-Me₃Ind)₂TiCl₂, Et(2,4,5,6,7-Me₅Ind)₂TiCl₂, Me₂Si(2-Me-4-PhInd)₂TiCl₂, Me₂Si(2-Me-4-PhInd)(2-i-PrInd)TiCl₂, Me₂Si(2-Me-(1-Naph)Ind)₂TiCl₂, Me₂C(Cp)₂TiCl₂, Me₂C(Cp)(Ind)TiCl₂, Me₂C(Cp)(2-MeInd)TiCl₂, Me₂C(Cp)(3-MeInd)TiCl₂, Me₂C(Cp)(3-t-BuInd)TiCl₂, Me₂C(Cp)(Flu)TiCl₂, Me₂C(Cp)(2,7-Me₂Flu)TiCl₂, Me₂C(Cp)(2,7-t-Bu₂Flu)TiCl₂, Me₂C(3-MeCp)₂TiCl₂, Me₂C(3-MeCp)(Ind)TiCl₂, Me₂C(3-MeCp)(2-MeInd)TiCl₂, Me₂C(3-MeCp)(3-MeInd)TiCl₂, Me₂C(3-MeCp)(3-t-BuInd)TiCl₂, Me₂C(3-MeCp)(Flu)TiCl₂, Me₂C(3-MeCp)(2,7-Me₂Flu)TiCl₂, Me₂C(3-MeCp)(2,7-t-Bu₂Flu)TiCl₂, Me₂C(3-t-BuCp)₂TiCl₂, Me₂C(3-t-BuCp)(Ind)TiCl₂, Me₂C(3-t-BuCp)(2-MeInd)TiCl₂, Me₂C(3-t-BuCp)(3-MeInd)TiCl₂, Me₂C(3-t-BuCp)(3-t-BuInd)TiCl₂, Me₂C(3-t-BuCp)(Flu)TiCl₂, Me₂C(3-t-BuCp)(2,7-Me₂Flu)TiCl₂, Me₂C(3-t-BuCp)(2,7-t-Bu₂Flu)TiCl₂, Ph₂C(Cp)₂TiCl₂, Ph₂C(Cp)(Ind)TiCl₂, Ph₂C(Cp)(2-MeInd)TiCl₂, Ph₂C(Cp)(3-MeInd)TiCl₂, Ph₂C(Cp)(3-t-BuInd)TiCl₂, Ph₂C(Cp)(Flu)TiCl₂, Ph₂C(Cp)(2,7-Me₂Flu)TiCl₂, Ph₂C(Cp)(2,7-t-Bu₂Flu)TiCl₂, Ph₂C(3-MeCp)₂TiCl₂, Ph₂C(3-MeCp)(Ind)TiCl₂, Ph₂C(3-MeCp)(2-MeInd)TiCl₂, Ph₂C(3-MeCp)(3-MeInd)TiCl₂, Ph₂C(3-MeCp)(3-t-BuInd)TiCl₂, Ph₂C(3-MeCp)(Flu)TiCl₂, Ph₂C(3-MeCp)(2,7-Me₂Flu)TiCl₂, Ph₂C(3-MeCp)(2,7-t-Bu₂Flu)TiCl₂, Ph₂C(3-t-BuCp)₂TiCl₂, Ph₂C(3-t-BuCp)(Ind)TiCl₂, Ph₂C(3-t-BuCp)(2-MeInd)TiCl₂, Ph₂C(3-t-BuCp)(3-MeInd)TiCl₂, Ph₂C(3-t-BuCp)(3-t-BuInd)TiCl₂, Ph₂C(3-t-BuCp)(Flu)TiCl₂, Ph₂C(3-t-BuCp)(2,7-Me₂Flu)TiCl₂, Ph₂C(3-t-BuCp)(2,7-t-Bu₂Flu)TiCl₂, Me₂C(Ind)(Flu)TiCl₂, Me₂C(3-MeInd)(Flu)TiCl₂, Me₂C(3-t-BuInd)(Flu)TiCl₂, Me₂C(3-t-BuInd)₂TiCl₂, Me₂C(3-t-BuInd)(2,7-t-Bu₂Flu)TiCl₂, Me₂Si(Ind)(Flu)TiCl₂, Me₂Si(3-MeInd)(Flu)TiCl₂, Me₂Si(3-t-BuInd)(Flu)TiCl₂, Me₂Si(3-t-BuInd)₂TiCl₂, Me₂Si(Cp)(t-BuN)TiCl₂, Me₂Si(Me₅Cp)(t-BuN)TiCl₂, Me₂Si(3-t-BuInd)(2,7-t-Bu₂Flu)TiCl₂, Ph₂C(Ind)(Flu)TiCl₂, Ph₂C(3-MeInd)(Flu)TiCl₂, Ph₂C(3-t-BuInd)(Flu)TiCl₂, Ph₂C(3-t-BuInd)₂TiCl₂, Ph₂C(3-t-BuInd)(2,7-t-Bu₂Flu)TiCl₂.

(C) Lewis Acid Compounds

(C) A Lewis acid compound composes a part of a catalytic component by reacting with a catalytic precursor in the general formula (1) when l=0. Lewis acid compounds are broadly classified into the following two types.

(C-1) Organoaluminoxy Compounds:

One of them is the organoaluminoxy compounds represented by the general formula (III):

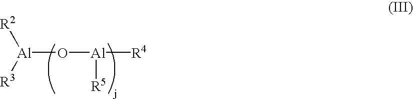

wherein, R²,R³and R⁴ may be identical to or different from one another, and are hydrogen atoms or hydrocarbon groups with from 1 to 10 carbon atoms, preferably methyl and i-butyl groups; R⁵ existing in multiple may be identical to or different from one another, and are hydrocarbon groups with from 1 to 10 carbon atoms, preferably methyl and i-butyl groups, and j is an integer from 1 to 100, and preferably the formula is an organoaluminoxy compound consisted of from 3 to 100 of mixtures.

These types of compounds can be produced using the methods known in the art. For example, a method for adding a trialkylaluminum to a suspension of a salt having crystal water (copper sulfate hydrate, aluminum sulfate hydrate, and the like) in a hydrocarbon solvent, or a method for applying solid, liquid or gaseous water to a trialkylaluminum can be enumerated.

When n is 2 or more and R⁵ are identical, one kind of trialkylaluminum is used. When n is 2 or more and R⁵ are different, two or more types of trialkylaluminums may be used, or one or more types of trialkylaluminums and one or more types of dialkylaluminun halide may be used. Specifically they are selected from trialkylaluminums such as trimethylaluminum, triethylaluminum, tri-n-propylaluminum, tri-i-propylaluminum, tri-n-butylaluminum, tri-i-butylaluminum, tri-s-butylaluminum, tri-t-butylaluminum, tri-(2,4-dimethylbutyl)aluminum, di-n-pentyl-n-butylaluminum, di-n-hexyl-n-butylaluminum, and dicyclohexyl-n-butylaluminum, dialkylaluminum halide such as dimethylaluminum chloride and di-i-butylaluminum chloride, as well as dialkylaluminum alkoxides such as dimethylaluminum methoxide, and among them, trialkylaluminum, especially trimethylaluminum and tri-i-butylaluminum are preferable.

(C-2) Boron Compounds:

Another group is the other Lewis acid compounds which form an ionic complex by reacting with a metallocene compound. Among them, boron compounds are preferred. Specifically, boron compounds having pentafluorophenyl, p-methyl tetrafluorophenyl and p-trimethylsilyl tetrafluorophenyl groups are preferred. Specifically Tris (pentafluorophenyl) boron, tetra (pentafluorophenyl)-tri-(n-butyl) ammonium borate, tetra (pentafluorophenyl) dimethyl anilinium borate, tetra (pentafluorophenyl) pyridinium borate, tetra (pentafluorophenyl) ferrocenium borate, and tetra (pentafluorophenyl) triphenyl carbenium borate are included. In the above catalytic system, organoaluminum compounds can be added if necessary as scavenger. Preferably organoaluminum compounds are selected from trialkylaluminum compounds such as trimethylaluminum, triethylaluminum, tri-ii-propylaluminum, tri-i-propylaluminum, tri-n-butylaluminum, tri-i-butylaluminum, tri-s-butylaluminum, tri-t-butylaluminum, tri-n-pentylaluminum, tri-n-hexylaluminum and tri-n-octylaluminum, dialkylaluminum halide such as dimethylaluminum chloride, diethylaluminum chloride and di-i-butylaluminum chloride, dialkylaluminum alkoxide such as dimethylaluminum methoxide and diethylaluminum ethoxide, dialkylaluminum aryloxide such as diethylaluminum phenoxide, or aluminoxan. Among them, trialkylaluminums, especially trimethylaluminum, triethylaluminum, tri-i-butylaluminum and tri-ii-octylaluminum are preferable.

The above catalytic system can be supported on a fine particle carrier as shown below. The average particle diameters of the fine particle carriers used herein are generally from 10 to 300 μm, preferably from 20 to 200 μm. The fine particles are not especially limited if only they are solid in polymerization solvents, and selected from organic and inorganic substances. As inorganic substances, inorganic oxides, inorganic chlorides, inorganic carbonates, inorganic sulfates, and inorganic hydroxides are preferable, and as organic substances, organic polymers are preferred. For inorganic carriers, oxides such as silica and alumina, chlorides such as magnesium chloride, carbonates such as magnesium carbonate and calcium carbonate, sulfates such as magnesium sulfate and calcium sulfate, as well as hydroxides such as magnesium hydroxide and calcium hydroxide can be exemplified. For organic carriers, fine particles of organic polymers such as polyethylene, polypropylene and polystyrene can be exemplified. The preferred are inorganic oxides, and especially silica, alumina and combined oxides thereof are preferable. Among them, porous fine particle carriers are especially preferred since few polymers adhere to inside walls of reaction vessels and thus resultant bulk density of the polymers becomes high. For such porous fine particle carriers, specific surface areas are preferably in the range of from 10 to 1000 m²/g, more preferably in the range of from 100 to 800 m²/g, and especially the range of from 200 to 600 m²/g is preferred. And for the pore volumes, the range of from 0.3 to 3 mL/g is preferable, and the range of from 1.0 to 2.0 mL/g is most preferable. The volumes of absorbed water and surface hydroxyl groups become different depending on their treatment conditions. The preferred water content is 5 wt % or less, and the preferred volume of surface hydroxyl groups is 1/nm² or more per surface area. The control of volumes of water contents and surface hydroxyl groups can be carried out by calcination temperature or treatment with organoaluminum compounds or organic boron compounds.

The contact timing of the oxidizing agents with the titanium complex and the Lewis acid compounds at the polymerization reaction can be optionally selected. For example, the method where after the titanium complex is first contacted with the Lewis acid compound (pre-contact) followed by contact with the oxidizing agent, this catalytic system is added to olefins thereby initiating the polymerization reaction is included. Or the method where the titanium complex is first contacted with the oxidizing agent followed by contact with the Lewis acid compound for polymerization may be used. Also, is employable a method in which the oxidizing agent and the olefin monomer are charged in a reaction vessel, and a catalyst comprising the titanium complex having the Lewis acid compound contacted there with is introduced thereinto, thereby initiating the polymerization. The concentrations of the catalyst components are not especially limited, but the molar ratio of [oxidizing agent]/[titanium complex] for the concentration of the oxidizing agent is from 10⁻³ to 10₁₀, and especially the range of from 10⁻¹to 10² is preferred. For the concentration of titanium complex, the range of from 10⁻³ to 10⁻¹⁰ mol/L is preferable. For the concentration of (C-1) the organoaluminoxy compound, the molar ratio of [aluminum atoms in organoaluminoxy compound]/[titanium complex] is from 10 to 10,000, especially the range of from 100 to 5,000 is preferable, and for the concentration of (C-2) the boron compound, the-molar ratio of [boron compound]/[titanium complex] is from 0.1 to 100, and the range of from 0.2 to 10 is most preferable.

When the oxidizing agent is gaseous, the objective of the present invention can be achieved by bubbling the oxidizing agent into the solution of titanium complex (and the contact solution of Lewis acid compound) at a flow rate of from 1 to 10⁸ mL/min for one or more seconds.

In a particular embodiment of the present invention hydrogen is used as oxidizing agent. Thus a further object of the present invention is a catalyst system obtainable by contacting:

(A) hydrogen;

(B) a titanium complex represented by the general formula (I);

Z R″ₘZ′TiQₖA₁ (I)

wherein

(a) Z and Z′ may be identical or different and each represents a π-bonding ligand or a σ-bonding ligand;

(b) R″ represents a bridging moiety;

(c) Q represents a straight or branched alkyl, aryl, alkenyl, alkylaryl, arylalkyl group or a halogen atom;

(d) A represents a counteranion;

(e) k is an integer from 1 to 3;

(f) l is an integer from 0 to 2; and

(g) m is an integer from 0 to 3; and

(C) a Lewis acid compound;

characterized in that hydrogen is bubbled in a solution of the titanium complex or in a solution of the reaction product of the titanium complex and the Lewis acid prior of the introduction of the catalyst system in the polymerization reactor.

Besides, polymerization of olefins can be carried out by any polymerization methods known in the art such as solution polymerization, slurry polymerization, gas phase polymerization and bulk polymerization. The condition of polymerization is not especially limited, but the temperature of polymerization at from −100 to 100° C. is preferable. And the control of molecular weights at polymerization can be performed by the methods known in the art, e.g., selection of the temperature and introduction of hydrogen.

Thus a further object of the present invention is a process for polymerizing one or more alpha olefins comprising the step of contacting under polymerization condition one or more alpha olefins in the presence of the catalyst system object of the present invention.

The olefins used for polymerization in the present invention can include ethylene, propylene, 1-butene, 1-pentene, 1-hexene, 1-heptene, 1-octene, 3-metyl-1-butene, 4-methyl-1-pentene, styrene, cyclopentene, and cyclohexene. These olefins can be polymerized alone or copolymerized with two or more types.

The following examples are given for illustrative and not limitative purposes.

### EXAMPLES

Synthesis of Ph₂C(3-t-BuCp)(2,7-t-Bu₂Flu)TiCl₂

(1) Dipheizyl (3-t-butyl-1-cyclopentadienyl)(2,7-di-t-butyl-9-fluorenyl)methane

11.4 g (41 mmol) of 2,7-di-t-butyl fluorene and 150 mL of diethyl ether were placed in 500 mL of a three-way-cock flask. 26 mL of the solution of 1.6 M n-butyl lithium in n-hexane was added at room temperature, and stirred at room temperature for 2 hours. 11.7 g (41 mmol) of 2-t-butyl-6,6-diphenyl fluben in 30 mL of n-hexane solution was added, and refluxed for 10 hours. Thereafter, the saturated ammonium chloride solution was added to the reaction solution, the organic layer was separated, and the solvent was evaporated to give the objective compound (yield 18 g, 78%).

(2) Dipheizyl Methylene (3-t-butyl-1-cyclopentadienyl) (2,7-di-t-butyl-9-fluorenyl)titanium dichloride, Ph₂C(3-t-BuCp)(2,7-t-Bu₂Flu)TiCl₂

5.8 g (10.2 mmol) of diphenyl (3-t-butyl-1-cyclopentadienyl)(2,7-di-t-butyl-9-fluorenyl)methane was dissolved in 50 ml of diethyl ether, 13 ml of the solution of 1.6 M n-butyl lithium in ii-hexane was dropped, and stirred at room temperature for 2 hours. The solvent was evaporated, and 100 mL of toluene was added. After cooling down to −78° C., 3.7 g (10.2 mmol) of titanium trichloride/THF complex was added, gradually warmed up to room temperature, and stirred for 12 hours. 2.8 g (10.2 mmol) of lead chloride, PbCl₂ was added and further stirred at room temperature for 5 hours. After the resultant suspension was filtered with a G-4 filter, the residue was washed with 100 mL of toluene. The extract was concentrated to isolate the objective titanium compound Ph₂C(3-t-BuCp)(2,7-t-Bu₂Flu)TiCl₂

### Example 1

Propylene Polymerization

4.5 mL of a solution of 0.5 M tri-i-butylaluminum (TIBA) in toluene and 8 mol of liquid propylene were placed in the SUS-made autoclave with an inner content of 1.5 L which was thoroughly replaced with nitrogen, while maintaining at 50° C. At the same time, the solution of 0.5 M of methyl aluminoxane (made by Tosoh Akuzo) in toluene was added to the solution of Ph₂C(3-t-BuCp)(2,7-t-Bu₂Flu)TiCl₂ in toluene (Al/Zr=1000), and reacted at 30° C. for 5 min. Further, hydrogen gas was bubbled into this reaction solution for 2 min. As the result, the color of the solution was turned from dark brown to light orange. This reaction solution was introduced into the autoclave to initiate polymerization. The polymerization was carried out at 50° C. for 30 min.

As the result, 9 g of isotactic polypropylene was obtained in white powder. The activity per titanocene compound was 19 kg-PP/mmol-Ti/h. The molecular weight, melting point and tacticity of the resultant polymer were measured and the following values were obtained; Mw=77,400, Mw/Mn=2.1, Tm=125° C., mmmm=74%.

### Comparative Example 1

The polymerization was carried out under the same condition as that in Example 1 except not bubbling hydrogen for 2 min.

Activity; 7 kg-PP/mmol-Ti/h, Mw=80,600, Mw/Mn=2.1, Tm=127° C., mmmm=73%

### Example 2

The polymerization was carried out under the same condition as that in Example 1 except introducing hydrogen at a hydrogen/propylene concentration ratio of 36 mol ppm into polymerization.

Activity; 133 kg-PP/mmol-Ti/h, Mw=48,600, Mw/Mn=2.2, Tm=127° C., mmmm=75%

### Comparative Example 2

The polymerization was carried out under the same condition as that in Example 2 except not bubbling-hydrogen for 2 min.

Activity; 58 kg-PP/mmol-Ti/h, Mw=60,100, Mw/Mn=2.8, Tm=125° C., mmmm=74%

### Example 3

The polymerization was carried out under the same condition as that in Example 1 except introducing hydrogen at a hydrogen/propylene concentration ratio of 145 mol ppm into polymerization system.

Activity; 132 kg-PP/mmol-Ti/h, Mw=43,900, Mw/Mn=2.9, Tm=129° C., mmmm=75%

### Comparative Example 3

The polymerization was carried out under the same condition as that in Example 3 except not bubbling hydrogen for 2 min.

Activity; 73 kg-PP/mmol-Ti/h, Mw=43,300, Mw/Mn=2.9, Tm=128° C., mmmm=73%

### Example 4

The polymerization was carried out under the same condition as that in Example 1 except introducing hydrogen at a hydrogen/propylene concentration ratio of 36 mol ppm into polymerization using threo-i-Pr(3-t-BuCp)(3-t-BuInd)TiCl₂ (synthesized according to Macromolecules, 1995, 28, 3074) as a titanocene compound in Example 1.

Activity; 20 kg-PP/mmol-Ti/h

### Comparative Example 4

The polymerization was carried out under the same condition as that in Example 4 except not bubbling hydrogen for 2 min.

Activity; 10 kg-PP/mmol-Ti/h

### Example 5

4.5 mL of the solution of 0.5 M tri-i-butylaluminum (TIBA) in toluene and 8 mol of liquid propylene were placed in the SUS-made autoclave with an inner content of 1.5 L which was thoroughly replaced with nitrogen, followed by maintaining the temperature at 50° C. At the same time, the solution of 0.5 M methyl aluminoxane (made by Tosoh Akuzo) in toluene was added to the solution of Ph₂C(3-t-BuCp)(2,7-t-Bu₂Flu)TiCl₂ in toluene (1.0 μmol)Al/Zr=1000), and reacted at 30° C. for 5 min. Further, 5.0 mg (20 μmol)of lead chloride(II) as an oxidizing agent was added to this reaction solution, and stirred for 2 min. As the result, the color of the solution was turned from dark brown to light orange. This reaction solution was introduced into the autoclave to initiate polymerization. The polymerization was carried out at 50° C. for 30 min.

As the result, 8 g of isotactic polypropylene was obtained in white powder. The activity per titanocene was 16 kg-PP/mmol-Ti/h. The molecular weight of the resultant polymer was Mw=83,700 Mw/Mn=2.3.

### Example 6

The polymerization was carried out under the same condition as that in Example 5 except adding 6.6 mg (20 μmol) of hexamethyl ditin as an oxidizing agent in Example 5.

Activity; 16 kg-PP/mmol-Ti/h, Mw=87,900, Mw/Mn=1.9

### Example 7

The polymerization was carried out under the same condition as that in Example 5 except adding 0.12 mL (1.0 mmol) of methyl iodine as an oxidizing agent in Example 5.

Activity; 22 kg-PP/mmol-Ti/h, Mw=88,500, Mw/Mn=2.3

### Example 8

The polymerization was carried out under the same condition as that in Example 5 except adding 5.1 mg (20 μmol) of iodine as an oxidizing agent in Example 5.

Activity; 23 kg-PP/mmol-Ti/h, Mw=86,900, Mw/Mn=2.1

1. a catalysts system comprising the product obtainable by reacting:
(A) an oxidizing agent which can oxidize Ti(II) and Ti(III), in a radical coupling manner;
(B) a titanium complex represented by the general formula (I);
Z R″ₘZ′TiQₖA₁ (I)
wherein
(a) Z and Z′ may be identical or different and each represents a π-bonding ligand or a σ-bonding ligand;
(b) R″ represents a bridging moiety;
(c) Q represents a straight or branched alkyl, aryl, alkenyl, alkylaryl, arylalkyl group or a halogen atom;
(d) a represents a counteranion;
(e) k is an integer from 1 to 3;
(f) l is an integer from 0 to 2;
(g) m is an integer from 0 to 3; and
(C) a Lewis acid compound.

2. The catalyst system according to claim 1 comprising
(A) an oxidizing agent which can oxidize Ti(II) to Ti(IV), in a radical coupling manner;
(B) a titanium complex of formula (II);
Z R″ₘZ′TiQₖ (II)
wherein
Z is an unsubstituted or substituted cyclopentadienyl group, optionally condensed to one or more unsubstituted or substituted, saturated, unsaturated or aromatic rings, containing from 4 to 6 carbon atoms, optionally containing one or more heteroatoms belonging to groups 13-17 of the Periodic Table of the Elements; Z′ is O, S, NR¹ or PR¹, R¹ being hydrogen, a linear or branched, saturated or unsaturated C₁-C₂₀alkyl, C₃-C₂₀ cycloalkyl, C₆-C₂₀ aryl, C₇-C₂₀ alkylaryl or C₇-C₂₀ arylalkyl, or Z′ has the same meaning of Z;
R″ is a divalent radical selected from the group consisting of: linear or branched, saturated or unsaturated C₁-C₂₀ alkylidene, C₃-C₂₀ cycloalkylidene, C₆-C₂₀ arylidene, C₇-C₂₀ alkylarylidene or C₇-C₂₀ arylalkyldene radicals, optionally containing one or more Si, Ge, O, S, P, B or N atoms;
Q is selected from the group consisting of, halogen atoms or a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl group, optionally containing one or more Si or Ge atoms;
k is 2; and
m is 0 or 1; and
C) a Lewis acid compound

3. The catalyst system according to claims 1 or 2 wherein the oxidizing agent is selected from the group consisting of: halogens; halogenated alkyl of formula R⁶T¹ₙ wherein T¹ a halogen atom, R⁶ is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl hydrocarbon in which n hydrogen are substituted with T¹ atoms and n ranges from 1 to 5; transition metal salts of formula T²T¹ₙ² wherein T² is a metal of group 8-15 of the periodic table, T¹ is a halogen atom preferably chlorine and n²w¹ is equal to 1 or 2 depending of the oxidation state of the metal; Organic transition metal compound of formula R⁶-T³-T³-R⁶ wherein R⁶, equal to or different from each other, is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl radical.

4. The catalyst system according to claim 3 wherein the oxidizing agent is selected from the group consisting of iodine, lead chloride, hexamethyl ditin and methyl iodide.

5. A catalyst system obtainable by contacting:
(A) hydrogen;
(B) a titanium complex represented by the general formula (I);
Z R″ₘZ′TiQₖA₁ (I)
wherein
(a) Z and Z′ may be identical or different and each represents a π-bonding ligand or a σ-bonding ligand;
(b) R″ represents a bridging moiety;
(c) Q represents a straight or branched alkyl, aryl, alkenyl, alkylaryl, arylalkyl group or a halogen atom;
(d) A represents a counteranion;
(e) k is an integer from 1 to 3;
(f) l is an integer from 0 to 2; and
(g) m is an integer from 0 to 3; and
(C) a Lewis acid compound;
characterized in that hydrogen is bubbled in a solution of the titanium complex or in a solution of the reaction product of the titanium complex and the Lewis acid prior of the introduction of the catalyst system in the polymerization reactor.

6. The catalyst system according to claim 5 wherein the titanium has formula (II);
Z R″ₘZ′TiQₖ (II)
wherein
Z is an unsubstituted or substituted cyclopentadienyl group, optionally condensed to one or more unsubstituted or substituted, saturated, unsaturated or aromatic rings, containing from 4 to 6 carbon atoms, optionally containing one or more heteroatoms belonging to groups 13-17 of the Periodic Table of the Elements; Z′ is O, S, NR¹ or PR¹, R¹ being hydrogen, a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl, or Z′ has the same meaning of Z;
R″ is a divalent radical selected from the group consisting of: linear or branched, saturated or unsaturated C₁-C₂₀ alkylidene, C₃-C₂₀ cycloalkylidene, C₆-C₂₀ arylidene, C₇-C₂₀ alkylarylidene or C₇-C₂₀ arylalkyldene radicals, optionally containing one or more Si, Ge, O, S, P, B or N atoms;
Q is selected from the group consisting of, halogen atoms or a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl group, optionally containing one or more Si or Ge atoms;
k is 2; and
m is 0 or 1.

7. A process for polymerizing one or more alpha olefins comprising the step of contacting under polymerization condition one or more alpha olefins in the presence of the catalyst system of claims 1-6.
